(19) United States
(12) Patent Application Publication
(10) Pub. No.: US 2012/0010910 A1
(43) Pub. Date: Jan. 12, 2012

(54) SYSTEMS AND METHODS FOR OPTIMIZING THE SCHEDULING OF RESOURCES ON AN AIRPLANE

(76) Inventors: Avinash S. Lele, Palo Alto, CA (US); Sanjeev R. Kulkarni, Princeton, CA (US)

(21) Appl. No.: 12/832,733

(22) Filed: Jul. 8, 2010

(51) Int. Cl. G06Q 10/00

(52) U.S. Cl. 705/5

(57) ABSTRACT

A system and method for enabling passengers to swap seats with other passengers, so that they may obtain seats that appear to be unavailable because they are occupied. Passengers use an interface to specify their desire and/or willingness to switch seats, and the conditions, if any, for switching. A processor runs an algorithm reassigning passenger seats based on the conditions inputted at the interface. Passengers are notified of their new seats, and may be charged or compensated for switching seats.

The present disclosure is directed to systems and methods for allocating seats to customers. It is particularly useful for optimizing the reassignment of seats on airplanes or in other contexts where seats are preassigned.

### BACKGROUND

Seating arrangements in various venues present logistical problems related to the allocation of the seats to potential customers. Customers may have individual preferences and there may be a finite number of seats having a specific set of attributes. For example, some football fans desire to sit at the 50 yard line while other prefer end zone seats. Additional logistical problems may be encountered if seats are controlled by different entities such as the stadium owner and ticketing and brokering service providers.

The present disclosure is directed to systems and methods for allocating seats that take into account the preferences of the customers when seats that satisfy those preferences are preassigned to other customers. Although the teachings of the present disclosure are applicable to any context in which seats are allocated to customers, the present disclosure is described with respect to the allocation of seats on an airplane as an example of the teachings and principles presented herein.

Many airline passengers care about which seat they sit in when they fly. A seat may have many different attributes including type of seat (aisle, middle, window, etc.), location on the plane (front, back, left, right, exit row, center section on a wide body jet, seats in the smoking section, etc.), class of service (first, business, economy, etc.), and other attributes. Many business travellers, for example, prefer aisle seats while children often want window seats so they can look out the window. On overnight flights, some people want aisle seats to avoid feeling trapped by their seatmate, while others want a window to lean against. Conversely, there are seats that many passengers do not want. Middle seats are a good example, because they do not offer the benefits of aisle seats or window seats and also make the passenger feel cramped. Bulkhead seats are another example of seats that some people try to avoid but that others prefer for the extra legroom.

In addition to type of seat, passenger preferences may be based on location. For example, some people prefer sitting near the front of the plane to be able to make a quick exit when the plane lands, while others prefer seats in the back to qualify for an earlier boarding group. Some people even have a preference as to the left or right side of the plane. Conversely, some passengers do not like seats in the last row, given their typical proximity to the lavatories. Passengers also sometimes try to avoid seats in front of an exit row if they do not recline.

Seat preferences can be so important to people that a number of services have been introduced in recent years to aid passengers in selecting their specific seats. Airline and third party services (e.g., Travelocity, Expedia) permit passengers to view a seat map and choose their specific seats online. Indeed, passengers are often given the opportunity to view what seats are available before they buy their tickets, making it possible to decide on a flight taking seat availability into account. Self-service check-in kiosks at the airport also enable a passenger to view her seat, see what other seats are not occupied, and switch to an unoccupied seat if desired. Passengers can also intelligently choose seats using third party services like seatguru.com, seatmaestro.com, and seatexpert.com to get information about the seating configuration of, and attributes and ratings of seats on, the flight the passenger is taking or thinking of taking.

These services and others make it easier and more convenient for passengers to choose seats they want, but they have a limitation—the only seats that a passenger can choose are those that are not already preassigned to another passenger. On relatively full flights, this usually means that only seats that are available for a passenger to choose from are the least desirable ones (e.g., middle seats, seats in the last row of the plane).

There is a need for a system and method for allocating seats to accommodate passenger seating preferences even on a plane that is full or nearly full, where passengers are willing to swap seats with one another. One example is a full plane where one passenger has an aisle seat but wants a window seat, and another passenger has a window seat but wants an aisle seat. But there is currently no way for passengers to know about and take advantage of such opportunities to swap seats, leaving some passengers dissatisfied with their seating when they need not be.

The present disclosure is directed to systems and methods for enabling passengers to switch to other seats, even when the desired seats have been preassigned to other passengers, by swapping seats with other passengers. In one embodiment, a user interface is provided whereby a passenger may submit a seat reassignment request that specifies conditions under which he would like to trade his preassigned seat for another seat. These conditions may include seat attributes that specify the type, location, and other attributes of seats that the passenger would like to trade for, and a trade value that specifies what, if anything, the passenger is willing to give to trade seats.

In one embodiment, the user interface also may be designed to enable a passenger to specify his willingness to give up his preassigned seat for another seat chosen by the airline. The passenger also may specify seat attributes that the new seat must satisfy for a trade to be made (e.g., that the new seat must be a window seat). The trade further may be conditioned on a trade value (e.g., an amount of money, airline miles, or some other form of compensation) that the passenger is willing to accept for giving up his preassigned seat. The system may be designed to enable a passenger to specify both a desire to trade a preassigned seat for a more desirable seat and a willingness to give up a preassigned seat for another seat chosen by the airline.

In one embodiment, the system may use a processor to compute a seat reassignment that achieves a sufficiently good or optimal value of a desired parameter (e.g., number of satisfied passengers, revenue generated by seat switches, etc.) using the passenger inputs. In this manner, the systems and methods of the invention may enable passengers to swap for seats that otherwise appear to be unavailable because they are preassigned to other passengers. Passengers may benefit by having more opportunities to get the seats they prefer or receiving remuneration for less desirable seats, and airlines benefit by increasing passenger satisfaction and/or revenues.

### BRIEF DESCRIPTION OF THE DRAWINGS

FIG. 1 is a simplified block diagram of one embodiment of the present disclosure.

FIG. 2 illustrates one embodiment of a user interface to select a seat from those that are unoccupied.

FIG. 3 illustrates one embodiment of a user interface to specify conditions for a seat swap.

FIG. 4 illustrates a simplified flow diagram of one embodiment of a method for a passenger to switch seats.

FIG. 5 illustrates a simplified flow diagram of one embodiment of a method for processing passenger seat reassignment requests.

### DETAILED DESCRIPTION

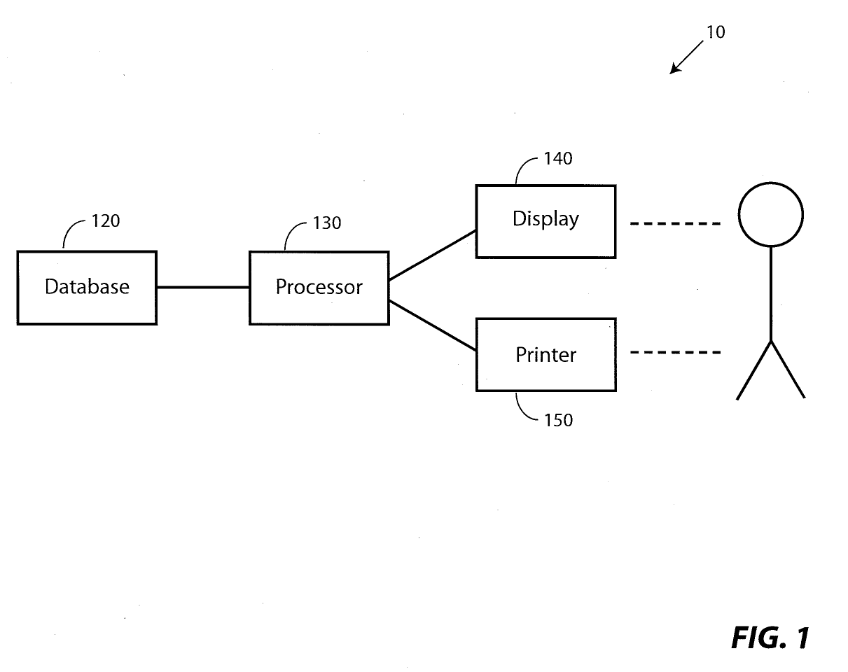

FIG. 1 shows a block diagram of a seating system 10 for an airline. Database 120 stores the seating configuration of the aircraft for a flight, seat assignments for the flight, and may include other relevant information such as passenger identification and frequent flyer status. In general, the database may store seat assignments for many or all of the airline's flights during a certain period of time (e.g., all flights in the next 365 days). For each seat on a given flight, the database contains information that either identifies the assigned passenger or reflects that the seat is currently unassigned.

Database 120 is coupled to a processor 130 that may perform a variety of functions, including updating seat assignments that are stored in the database. The processor may also access one or more of the seat assignments so that they may be displayed to a passenger or other end user on display 140. The display may be the screen of a laptop, desktop computer, or smartphone, or other device operated by the user, or a screen built into an airport check-in kiosk. In the former case, information would be communicated between processor 130 and display 140 over the Internet or some other network (not shown). The processor may be coupled to a printer 150 so that an end user may print a boarding pass or other document reflecting his or her seat assignment. The printer may be coupled to the user's laptop or other device.

Although system 10 is described in the context of being operated by an airline, it need not be. For example, it may be the system for several airlines, part of one airline, or a third party such as a consolidator, travel agency, or service like Travelocity or Expedia.

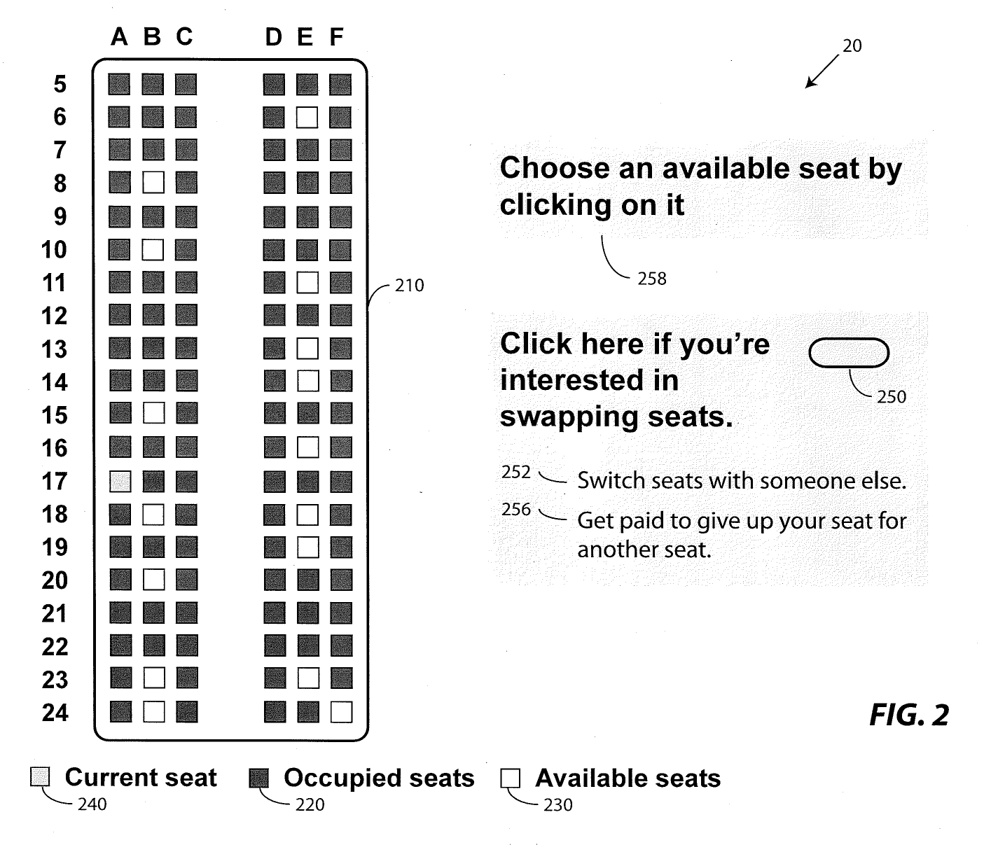

FIG. 2 shows one embodiment of a user interface 20 that may be displayed on display 140 to enable a passenger to select seats on a particular flight. Seat map 210 uses color coding (shown here in the form of grayscale shading) to show which seats 220 have been preassigned to other passengers and which seats 230 are still unoccupied. If the passenger has been preassigned to a seat, his current seat 240 may be shown as well. In general, the seat map will differ from flight to flight depending on the aircraft anticipated to be used for the flight and the seating configuration for the aircraft (e.g., 3-3 as shown, 2-3-2, etc., where the hyphen indicates an aisle on the plane). Furthermore, on larger planes, only a portion of the seat map may be shown at a time, with a scrolling feature to show seats in other parts of the plane. The passenger may select a seat, or switch to another seat, by clicking on an unassigned seat 230, in which case the seat map and database are updated to reflect the passenger's new seat 240 and (if the passenger switched seats) a newly available seat 230.

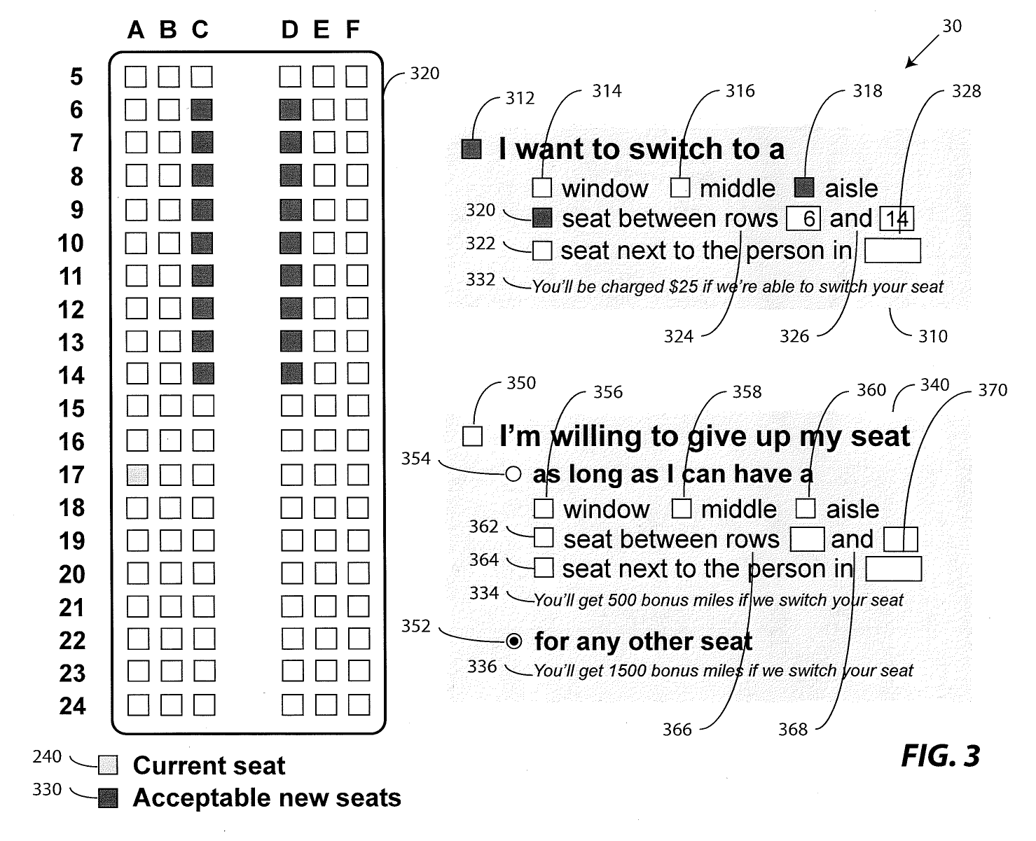

It may be the case that the passenger is not satisfied with his seat (or any of the unassigned seats 230 that he could switch to), or that the passenger is willing to give up his seat for another seat, perhaps for appropriate compensation. In those cases, the passenger may press button 250 to request a seat reassignment. Pressing button 250 enables the passenger to try to switch seats with other passengers, including switching to a more desirable seat 252 or giving up the current seat 256, Pressing button 250 displays the user interface 30 of FIG. 3, which includes a seat map that initially displays the passenger's current seat 240. In the example shown, the current seat is 17A, a window seat on the left in row 17.

Referring to FIG. 3, interface 30 includes a first region 310 wherein the passenger may click checkbox 312 to specify his desire to switch to another seat and select seat attributes for the desired seat. Clicking on one or more of checkboxes 314-320, together with notice 332, specify the conditions for the switch. The first row of checkboxes 314-318 is used to specify the types of seat (window/middle/aisle) that are acceptable. The checkbox 320 in the second row is used to specify the locations of seats (which rows on the plane) that are acceptable.

For example, if the user wants to try to swap his current seat 240 for an aisle seat between rows 6 and 14, he may click on checkboxes 318 and 320, and then fill in fields 324 and 326 with the numbers “6” and “14,” To provide visual feedback to the user, seat map 320 shows the “acceptable new seats” 330 that correspond to the checkboxes and fields that have been selected. Additionally, more than one of checkboxes 314-318 may be checked if the user does not require a specific type of seat. That is, if the user is willing to take either a window or an aisle, he may click on checkboxes 314 and 318.

Many variations on the above are possible (i.e., many other seat attributes may be designated for selection by the passenger). For example, the passenger may specify other types of seats (e.g., bulkhead seats, exit row seats, seats that recline, seats that have a power outlet, video screen, Internet connection, airphone, etc.). Conversely, the interface could allow a passenger to specify seats that he is not willing to take (e.g., a bulkhead seat, a non-reclining seat, etc.). Indeed, the interface could permit a specification of acceptable and unacceptable seat attributes (e.g., window seat but not a bulkhead). Other ways to specify desired or undesired location (e.g., left or right side of plane, not the center section on a wide body aircraft, or front third/middle third/back third of plane) or seating companion (e.g., using the other passenger's record locator instead of the current seat number) may be used as well.

Additionally, checkboxes 314-20 may be preset in their default state to being “unselected” (in which case the passenger would click on the checkbox to select it) or “selected” (in which case clicking would deselect). Indeed, some may be preset to unselected while others are preset to selected, based perhaps on expected passenger inputs or airline preferences.

The interface could also be designed to enable a user to use a mouse, finger, touch screen, stylus, or other selection device to select and/or deselect seats directly on seat map 320. This feature may be used in lieu of, or in addition to, the checkbox interface described above. For example, instead of clicking on any checkboxes, the user could use his mouse to click on seats 7A, 12F, 22A, and 22C if those were the only seats the user wished to try to trade for. Or the user could use the mouse to draw a rectangular “bounding box” whose corners are at seats 6C, 6D, 14C, and 14D as an alternate way to specify the same seats 330 that are shown in FIG. 3 as being acceptable. Then, for example, a superstitious user could click on individual seats 13C and 13D to deselect them and indicate his willingness to sit in any aisle seat in rows 6 to 14 except row 13.

In the example shown in FIG. 3, notice 332 reflects a trade value that has been prespecified by the airline. That is, the seat reassignment request includes a seat attribute chosen by the passenger and a trade value prespecified by the airline. In another embodiment, first region 310 may include a space for the passenger to input a trade value (which may be zero) to indicate what, if anything, the passenger is willing to pay in order to switch to a seat having the requested seat attributes. The trade value can be cash, airline miles, or any other form of payment accepted by the airline and may be presented to the passenger in the form of a pull-down menu. The passenger may also be able to designate from a choice of accounts from which to make the payment including credit card, bank account, frequent flyer account, PayPal account or similar type of account.

The interface of FIG. 3 also includes a second region 340 that may be used to enable a passenger to indicate her willingness to give up her current seat for another seat. In this case, the passenger clicks on checkbox 350. If she is willing to give up her current seat for any other seat of the airline's choice, the passenger selects radio button 352, and the trade is conditioned on the trade value reflected in notice 336. In this case, the seat attribute reflects the fact that every seat on the plane is acceptable to the passenger. Otherwise, the passenger selects radio button 354 to indicate her willingness to give up her current seat for another seat as long as the switch satisfies the requested seat attributes specified by checkboxes and fields 356-368 and the trade value specified by notice 334. For example, if the passenger is willing to give up her current seat 17A for any other window seat, she would select radio button 354 and checkbox 356. As another example, a passenger could specify a willingness to give up a business class seat for a coach seat if he is compensated appropriately (e.g., being paid $200 or 20,000 airline miles for the switch).

Although region 340 is similar to region 310 in terms of choices that are available to the user, it need not be. The choices may be different. Similarly, variations described above for region 310 may be implemented for region 340. Additionally, it may be the case that passengers are willing to switch for no money or miles (e.g., by receiving some form of recognition or merely the satisfaction of helping a fellow passenger). And, as described in connection with first region 310, second region 340 may include a space for the passenger to input a trade value to indicate what the passenger is willing to accept to give up his current seat. This would be an alternative to a trade value prespecified by the airline, as in notices 334 and 336. The trade value can be monetary or non-monetary and can include cash, cash equivalent (e.g., a prepaid card, gift card, etc.), credit, airline miles, rewards points, food/drink vouchers, free seat switch on a future flight, special recognition by the flight crew or on a website, etc, and may be presented to the passenger in the form of a pull-down menu. The passenger may also be able to designate from a choice of accounts into which it wants to receive payment including credit card, bank account, frequent flyer account, PayPal account or similar type of account.

As shown in interface 30 of FIG. 3, a user may click on checkboxes 312 and 350 to indicate multiple reassignment requests in the form of a simultaneous desire to try to trade for a more desirable seat and willingness to give up the current seat for some other seat. This may be an attractive strategy in certain situations, e.g., where the user is trying to get a certain kind of seat but, as a fallback, is willing to give up his seat in exchange for compensation. Alternatively, interface 30 may be implemented with radio buttons instead of checkboxes 312 and 350 to require the user to choose between regions 310 and 340 (trade for another seat, or indicate a willingness to give up a seat, but not both).

In addition, interface 30 could be implemented to allow a passenger to specify multiple seat attributes and trade values as part of multiple reassignment requests. For example, a passenger could specify that he is willing to pay $10 for a window seat, $20 for an aisle seat, or $150 for an upgrade to any seat in the next class of service.

Also, many variations are possible regarding the trade value offered by a passenger trading for a different seat and the trade value received by a passenger willing to give up their seat. As mentioned above, different types of trade values may be designated as a condition for switching seats. The amount of payment could vary depending on the nature of the seats requested. For example, certain rows or window/aisle seats might require more payment for a passenger requesting to switch to these seats. Or, the payment may increase with the number of conditions the passenger imposes on the seats he is willing to accept. Likewise, more flexibility on the part of passengers willing to give up their seats might result in greater payment to those passengers. Furthermore, the type of payment may vary depending on whether a passenger will be making or receiving payment. For example, passengers requesting a seat swap could be rewarded in one currency (e.g., airline miles or a food/drink voucher) and charged in some other currency (e.g., cash). Also, it may be useful to refer to a trade value as being positive or negative depending on whether the passenger is incurring a cost (e.g., positive trade value) or obtaining a benefit (e.g., negative trade value) for the seat reassignment. These and other variations may result in suitable modifications to the user interface presented to passengers.

In one embodiment, some or all of the trade value paid by a customer may be used to pay the trade value received by a passenger for a successful seat swap. In the case where a passenger has offered to pay more for a seat swap than another passenger has requested to give up a seat, the airline may keep the difference as an additional source of revenue. In the case where a passenger has offered to pay less than another passenger has requested to give up a seat, the airline may pay the difference in order to make more seats available for swap and increase customer satisfaction. In another embodiment, the airline may outsource the seat swap process to a third party provider who may be compensated by the airline, or be compensated by the trade values associated with the seat reassignment. For example, the airline could provide access to its database containing seat attributes and passenger information to the third party provider, and the third party provider could provide such information to the passengers via a user interface hosted on the third party's computer server. The third party provider could require that the passenger provide its record locator or other confirmation number with its seat reassignment request to ensure the seat assignment request is authentic. The third party provider can provide the airline with the seat reassignments indexed by the airline confirmation number provided by the passenger so that the airline can track the seat reassignments and take the appropriate actions. In yet another embodiment, trade values may be paid (i.e., may flow) directly between passengers instead of between each passenger and the airline. In this case, the airline or a third party might take part of the trade value as a fee or commission.

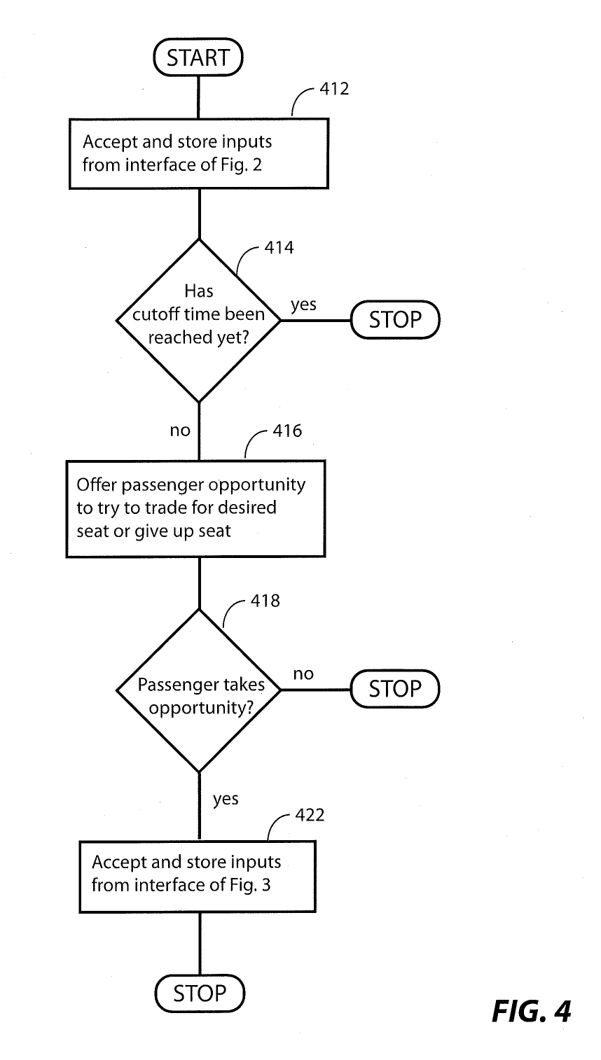

FIG. 4 is a flowchart of a process that may be run on processor 130. In step 412, user interface 20 of FIG. 2 is displayed on display 140, enabling the user to select a seat or switch to another seat by choosing an unoccupied seat. In one embodiment, the airline may establish a cut-off time, e.g., 24 hours before flight time, before which all seat requests must be made. If cut off time has been reached 414, no further seat swap requests are accepted. If cut-off time has not been reached, button 250 and accompanying text 252 may be displayed, offering the passenger an opportunity to swap seats with another passenger 416. If the passenger elects to make a seat reassignment request 418, a suitable interface such as interface 30 of FIG. 3 may be displayed, enabling the user to specify in step 422 her desire to trade for a new seat and/or her willingness to give up her seat for another by selecting seat attributes and specifying a trade value if applicable.

In one embodiment, once a cut off time has been reached the system implements an algorithm to identify a new set of seat assignments that achieves a sufficiently good or optimal value of a desired parameter (e.g., number of satisfied passengers, revenue generated by seat switches, etc.). The system may notify affected passengers of their new seat assignments (e.g., via telephone, mail, email, text, or social net-working) and charge or compensate passengers as appropriate. When a passenger obtains his boarding pass (e.g., by printing it online or obtaining it at an airport kiosk or from a ticket agent), the boarding pass will reflect the new seat assignment, and may indicate that a switch has been made together with indication of any payment or compensation.

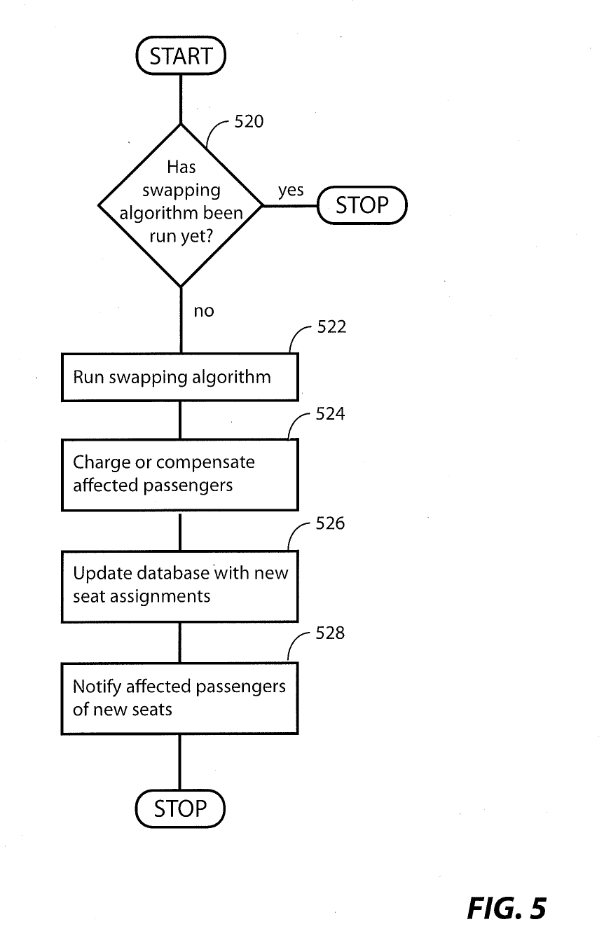

FIG. 5 illustrates one embodiment of a method to re-allocate seats. Once the cut-off time has been reached (and if any passengers have inputted information using interface 30), processor 130 determines whether it has already run an algorithm in step 520. The algorithm, an example of which is described in greater detail below, takes passenger data inputted in step 422 using interface 30 and processes that data to yield a set of new seat assignments that is deemed to be sufficiently good according to some selectable metric, i.e., in terms of the number of seat switches that are accomplished, revenue to the airline, etc. If the algorithm has not yet been run, it is run in step 522. Then, in step 524, passengers whose seats have been switched are either charged or provided compensation in accordance with the conditions set forth in the seat request. The processor may accomplish this step by charging the credit or debit card that is on file (e.g., that the passenger used to purchase her ticket), deducting miles from or crediting miles to a mileage account, issuing a coupon for free food/drinks using printer 150, etc. Then, in step 526, database 120 is updated to reflect seat reassignments and affected passengers are notified of their new seat assignments in step 528.

Many variations on the above flowchart are possible. For example, it may be desirable to confirm, in advance of running the algorithm in step 522, that each passenger requesting a seat reassignment will be able to pay for the swap. This could be accomplished by running a preauthorization of the credit card at the time the passenger uses interface 30, and requesting a different form of payment if the preauthorization is declined. Or, in the case of airline miles, the passenger's mileage account could be checked, and the appropriate number of miles could be provisionally deducted or frozen, pending a successful seat swap involving that passenger in step 522.

Also, it may be desirable to run the algorithm more than once. For example, certain passengers may be willing to pay more to have their seats swapped when a match becomes available (or at least without having to wait until, say, 24 hours before the flight time). In this case, the algorithm could be run in advance for those passengers, and again later on, and more times in between, as appropriate. For example, the algorithm could be run periodically, e.g., hourly, daily, etc, or could be run on a rolling basis every time a new seat request or certain number of seat requests are received.

In one embodiment, the cut off time may be selected such that it is earlier than the first time when passengers may check in and print their boarding passes. However, swapping even after passengers are allowed to check in and print their boarding passes is possible. In this case, if passengers are swapped, they could be notified, for example, by a text message, email, or at the gate at the time of boarding. The payments to/from passengers could be different for swaps made after a cut-off time. For example, a passenger could be charged more if a change request is made and accommodated after passengers are allowed to check in and print boarding passes.

Many different algorithms may be used to process the seat requests and find a suitable solution. Before discussing these algorithms, it is useful to introduce certain terminology as background. An airline passenger typically, though not always, selects or is assigned a seat in advance of his flight, in which case we will say that the passenger is preassigned a seat or that the given seat is preassigned to the passenger. Although the passenger may wish otherwise, it is understood by convention that a seat change may not be possible and that the passenger may have no choice but to remain in his preassigned seat. We will say that the preassigned seat is a valid seat for the passenger even though he may desire or be willing to switch to a different seat.

In addition to his preassigned seat, the passenger may indicate seat attributes and trade values for a seat switch. Any seat to which the passenger indicates a desire or willingness to switch (based on the indicated seat attributes and trade values) will also be called a valid seat for that passenger. If a passenger is preassigned a seat and does not indicate an interest and/or willingness to switch to other seats, then the preassigned seat is defined to be the only valid seat for this passenger.

If a passenger who has not been preassigned a seat has preferences that can be accommodated with seats that are available to him (i.e., unoccupied) at that time, then he can simply select a seat satisfying his preferences. If not, then he can still select any of the available seats. In either case, if the passenger selects a seat then the he will then be considered a preassigned passenger preassigned to the seat he selects. If a passenger does not select one of the available seats and thus remains without a preassigned seat, then every seat will be considered to be a valid seat for the passenger. Such a passenger may or may not provide seating preferences with seat attributes and trade values, and if provided, these may, though need not, be taken into consideration in the reassignment.

Depending on characteristics of the passenger and constraints imposed by the airline, the FAA, or some other agency, certain seats may automatically be defined as invalid seats for that passenger. For example, if the passenger is a child then a seat next to an emergency exit may be defined to be invalid.

A configuration refers to an assignment of each of the preassigned passengers to a unique seat. A configuration is called valid if every preassigned passenger is assigned to a seat that is valid for that passenger, according to that passenger's criteria as described above. Otherwise, the configuration is called invalid. That is, a configuration is invalid if at least one preassigned passenger is assigned to a seat that is invalid for that passenger.

Since the preassigned seat is always a valid seat for a passenger, the preassigned configuration is always a valid configuration. However, while the preassigned configuration is valid in the sense defined above, there may be other configurations that are more desirable in terms of accommodating preferences of one or more of the passengers. To achieve these more desirable configurations, it may be necessary to move one or more of the preassigned passengers to different seats.

In the prior art, individual passengers are able to switch their seats independently of one another based on their own individual seating requirements, but moving passengers based on joint consideration of their seating requirements or jointly moving two or more passengers has not been practiced. The joint consideration of passengers enables efficient movement to desirable configurations that would be inefficient, unlikely, or impossible with individual moves. The three cases below illustrate examples of the benefits of jointly considering reassignment requests.

Case 1. In some situations, a sequence of individual moves can lead to new configurations that fulfil preferences of multiple passengers. For example, suppose passenger 1 is preassigned to an aisle seat but would prefer a window seat, while passenger 2 is preassigned to a window seat but would prefer an aisle. If there are window and/or aisle seats available or if one of these types of seats becomes available through some other passenger switching their seat or cancelling their ticket, then it may be possible that both passengers 1 and 2 are able to fulfil their desire by independently switching their seats. Specifically, one of the passengers, say passenger 1, might notice that a window seat has become available and change his seat. At a later time, passenger 2 then notices that the aisle seat that was vacated by passenger 1 is available and she can move to this aisle seat. Such a move may or may not occur depending on whether the passengers check availability at the right times. However, the present invention enables an efficient method for accomplishing such a switch by jointly using the preference information of multiple passengers. Without joint consideration of reassignment requests, the moves of individual passengers are uncoordinated, making the desired sequence of moves less likely to occur since it requires a sequence of moves to occur independently when there may be a very large number of possible moves. On the other hand, by jointly considering the reassignment requests, the moves of multiple passengers can be coordinated to achieve the desired passenger moves.

Case 2. In other cases, while it is possible to make a sequence of individual switches to a more desirable configuration, the required individual switches generally do not occur in practice. For example, as before suppose that passenger 1 is preassigned to an aisle but would like a window, while passenger 2 is preassigned to a window but would like an aisle. Suppose that a middle seat is available, but that neither passenger wants a middle seat. That is, they both prefer their current seat over a middle seat. Then, in principle, the following sequence of individual switches could occur. One of the passengers, say passenger 1, could switch from his aisle seat the available middle seat. This would open an aisle seat, into which passenger 2 could switch. Then passenger 1 could switch into the open window seat vacated by passenger 2.

While this sequence of individual switches may be theoretically possible, in practice passenger 1 will not make the first individual switch since he is moving to a less desirable seat and does not know that further switches might occur which might lead to a more desirable seat. In the terminology above, the first switch moves passenger 1 into a seat he considers invalid, so that the sequence of individual switches passes through an invalid configuration on the way to the final desired configuration.

On the other hand, with the present invention, by jointly considering the reassignment requests of both passengers, the desirable configuration can be computed and performed. With a joint switch of passengers 1 and 2, the original configuration can be transformed in one step to the final desired configuration. Or, if transitions through invalid configurations are allowed, then a joint switch can be mimicked by a sequence of individual switches by first placing one passenger in the empty middle seat as described above. This sequence of switches may be one of many algorithmic approaches for computing desirable configurations even though passengers are not actually reassigned or notified of the intermediate steps.

Various other attempts can be made to try to mimic the moves that can be made through joint consideration of reassignment requests using a sequence of individual moves that try to circumvent the notion of transitions through an invalid configuration described above. For example, one can take a particular empty seat in a flight and define it as valid for every passenger. In this way, one can transition from any valid configuration to any other valid configuration by using this special seat that has been defined to be universally valid as swing space that makes it possible to move passengers around while always maintaining a valid configuration. Another possibility is to create phantom seat that does not actually exist and define this as a seat that is valid for all passengers. One can then again move from any valid configuration to any other valid configuration without passing through an invalid configuration. However, a problem with these and other similar attempts is that if the notion of valid seats does not conform with desires of the passengers, then passengers will be unlikely to make the seat changes needed to move from one valid configuration to another. On the other hand, by jointly considering the reassignment requests of multiple passengers, the airline or other third party that is carrying out the reassignment can facilitate moves that would otherwise be unlikely to take place.

Case 3. There are also cases in which it may not be possible to accommodate passengers 1 and 2 by a sequence of individual switches. For example, suppose the flight is full and all passengers are preassigned seats. Then there are no empty seats for any passengers to switch to. Yet, by jointly considering the preferences of passengers 1 and 2, a more desirable configuration can be computed and by jointly switching passengers 1 and 2 it is possible to fulfil the desires of both of these passengers. Namely by putting passenger 1 in the seat preassigned to passenger 2 and putting passenger 2 in the seat preassigned to passenger 1, both passengers are accommodated. In this case, one can try to mimic jointly moving passengers 1 and 2 by creating an extra empty phantom seat and making individual moves using this phantom seat. However, again such moves will not occur in practice with passengers making individual moves in an uncoordinated fashion since individual passengers are unlikely to choose to move into the phantom seat. This and other methods that do not coordinate the reassignment requests cannot efficiently make the moves that can be facilitated by jointly considering the reassignment requests.

In situations like Case 1 above, a sequence of individual passenger moves exists to transform the preassigned configuration to a new valid configuration where each move is a valid move. In this sense, we will say that the two configurations are connected, or that the two configurations are part of the same connected component of valid configurations. However, while every move is valid and so can be realized by individual valid moves, the transition can be made much more efficient by jointly considering the reassignment requests. In situations like Case 2, every sequence of individual passenger moves that transitions from the preassigned configuration to the new valid configuration passes through an invalid configuration. In this sense, the preassigned configuration and the reassigned configuration are not connected. That is, the two configurations are not part of the same connected component of valid configurations. In this case, while it is possible to sequentially move individual passengers to achieve the reassigned configuration, such a sequence is not likely to occur because it requires one or more passengers to make a move that the passenger does not desire. In situations like Case 3, no individual moves are possible since there are no empty seats.

Given this background, we turn to a discussion of algorithms that may be run by processor 130 to accomplish seat reassignments. In step 522 of FIG. 5, one such algorithm is run to determine which seat changes if any will be made. The algorithm used to identify a new set of seat assignments may attempt to find a sufficiently good or optimal value of a desired parameter (e.g., number of satisfied passengers, revenue generated by seat switches, etc.).

While a variety of methods could be used to determine a satisfactory set of new seat assignments, described below is one suitable embodiment. Let N denote the number of seats on the aircraft under consideration on the aircraft. Let K denote the number of passengers under consideration. For example, if first class seats and passengers are not part of the switching possibilities, they can be excluded from the N seats and K passengers, respectively. For each passenger i=1, 2, . . . , K, database 120 contains information on the details of the passenger. And for each seat j=1, 2, . . . , N, the database contains information on seat attributes such as the location and type of seat (e.g., which row and position the seat is in, whether it is a window, middle, or aisle, etc.). This information depends on information about the type of aircraft used for the particular flight which is also contained in database 120.

Each passenger needs to be assigned to a unique seat. Let xij=1 if passenger i is assigned to seat j, and xij=0 otherwise. In order to have a valid seat assignment, it is required that for every i, xij=1 for exactly one j, and for every j xij=1 for at most one i.

$${\sum }_{j = 1}^{N} {x}_{ij} = 1 for every i$$

$${\sum }_{i = 1}^{N} {x}_{ij} \leq 1 for every j$$

$${x}_{ij} ∈ \{ 0 , 1 \}$$

The first condition ensures that every passenger is assigned to exactly one seat. The second condition ensures that every seat has at most one passenger that is assigned to that seat.

Let aij represent the value to the airline for assigning passenger i to seat j. Then to maximize the value of the resulting seating assignments, the algorithm run by processor 130 could aim to maximize the following objective function:

$${\sum }_{i = 1}^{K} {\sum }_{j = 1}^{N} {c}_{ij} {x}_{ij}$$

subject to the conditions above on the xij. This objective criterion maximizes the total value to the airline (as represented by the aij) subject to the constraint that the resulting choice of the xij represents a valid seating assignment.

This formulation can accommodate a number of desirable settings. For example, aij could represent the dollar amount passenger i is willing to pay to the airline if the airline is able to switch that passenger to seat j. For example, if passenger 3 is willing to pay $25 to switch to any of seats 8, 9, and 21, and is willing to pay $50 to switch to seat 46, then we can set a3,8=25, a3,9=25, and a3,21=25, and set a3,46=50.

If a passenger is willing to give up his or seat for another in exchange for a payment from the airline, then aij could be a negative quantity representing the dollar value of the payment made to passenger if the airline moves them to seat j. For example, if passenger 7 is willing to switch her seat for $10 as long as her new seat is one of seats 15, 16, 17, and is willing to give up switch her seat for $5 as long as her new seat is seat 18, then we might set a7,15=−10, a7,16=−10, a7,17=−10, and a7,18=−5.

The aij may be, but need not be, set in accordance with the trade values. For example, in some cases, the aij may be set to reflect the actual or perceived cost/benefit to the airline. Thus, if passenger 12 is willing to give up her seat for any other seat of the airline's choosing in exchange for being recognized on a website, the trade value to the passenger may be non-zero, but the cost to the airline may be zero. In this example, a12,j may be set to zero for all values of j.

The flexibility in setting the aij allows the revenue to be different for every choice of passenger and seat. When the aij represent revenue to the airline, the objective criterion above maximizes the total revenue to the airline. Alternatively, aij could be chosen in a way to maximize the number of changes by letting aij be some fixed positive quantity (e.g., +1) when a change is made regardless of the change. This could be useful if revenue is less important to the airline than accommodating customer requests.

For passengers who are preassigned to a seat and are unwilling to move, the aij can be chosen to accommodate this, by setting the value of the current seat assignment to 0 and the value of all other seats to a sufficiently large negative quantity (for example, a negative number with magnitude larger than the sum of all the positive aij). For example, if passenger 2 is currently assigned to seat 5 and does not wish to move, then a2,5 is set to 0 and a2,j is set to a sufficiently large negative quantity for all j not equal to 5. Or, if there are only certain seats to which passenger 2 is unwilling to move, then only these corresponding a2,j are set to the sufficiently large negative value.

Any of a number of efficient algorithms exist and may be used by processor 130 to find a suitable assignment. In one embodiment, an approach is to consider all possible seat assignments and for each assignment compute the corresponding value of the objective function, and then select the assignment that gives the largest value for the objective function. In another embodiment, another approach is based on the linearity of the objective function and constraints in the variables xij. By allowing the xij to take on positive real values (i.e., replace the constraint that xij belong to {0,1} by the constraint that xij be nonnegative), processor 130 may use standard linear programming techniques to carry out the optimization. (The terms “optimization,” “optimize,” and other variants as used herein are not limited to the global maximum of a parameter but also include sufficiently good outcomes, e.g., where a parameter exceeds a predetermined criterion or threshold.) In yet another embodiment, the Hungarian algorithm (also known as the Kuhn-Munkres algorithm or Munkres algorithm) may be used.

The systems and methods described above may be applied to seat swaps that involve different flights or even different airlines. For example, a businesswoman who has a seat on a 5 pm flight may prefer a seat on a 7 pm flight, while a businessman may have and want the opposite. The teachings of the present disclosure could be used to implement systems and methods that permit these two passengers to switch seats (and flights) even if both flights are full. In this case, the desired flight number could be specified as a seat attribute in the reassignment request. Likewise, where flights on different airlines are involved, the name of the desired airline and flight number could be specified as seat attributes. In this case, various parts of system 10 might be implemented by multiple airlines (e.g., multiple databases instead of one database 120) and/or by a third party (e.g., processor 130 could be operated by a third party).

The systems and methods described above also may be applied to a variety of contexts other than airline seating. Seats on trains and other common carriers are some examples. Sporting events, concerts, shows, and other entertainment events are other examples. As in the context of airline seating, in these other contexts a suitable user interface would be used by ticketholders to specify a desire or willingness to switch seats and the conditions, if any, for switching, and a processor would be used to run an algorithm to reassign ticketholders to new seats. Ticketholders would then be notified of their new seats, and may be prompted to print new tickets reflecting the new seats, or may be sent new tickets by mail or electronically.

Although the teachings of the present disclosure are applicable to any venue offering seating arrangements to its customers, it has particular applicability to the airline industry due to the historically based ticketing policies of the airline industry. For example, the airline industry sometimes faces criticism for not providing a satisfactory “customer experience”. Some airlines shift prices and offer different prices for the same seat based on factors that are not always transparent to the customer. As such, it is sometimes common for passengers in adjacent seats to have paid very different prices for their respective seats. Likewise, airlines sometimes increase fares as the flight time gets closer such that a last minute flyer pays a much higher price than other passengers. However, the last minute passenger will typically have a less desirable seat than those passengers that booked earlier at lower prices. The present disclosure may ameliorate some of the effects of the airlines' pricing by enabling a last minute flyer, who may be willing to pay more, to swap his seat for a more desirable seat. Use of the present disclosure may assist an airline in encouraging passengers to book early to secure the most desirable seats, which can be traded later for value, thus reducing the passengers' total expense for the flight. An additional benefit to the airline and its customers is that the collection and analysis of information related to seat swapping, such as trade values for various seat attributes, may afford the airline industry the ability to modify their ticketing procedures to take into account their customers' preferences.

Due to security regulations and constraints, the airline may need to approve seat swaps. However, the airline may enter into relationships with third party providers to allow access to airline passenger and seating information in order to implement the present disclosure.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims. Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, a composition of matter affecting a machine-readable propagated signal, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

What is claimed:

1. A method for reassigning seats for airline passengers who have preassigned seats on a flight, the method comprising:
providing a memory containing information identifying a plurality of passengers and their preassigned seats, and seat attributes for the flight;
providing a user interface for displaying information regarding the preassigned seats;
receiving via the user interface seat reassignment requests from the passengers, the requests including at least one seat attribute and one trade value;
storing in the memory the seat reassignment requests;
accessing from the memory information regarding the passengers, preassigned seats, seat attributes, and seat reassignment requests;
using a processor to compute a configuration of reassigned seats, wherein the computation jointly uses the reassignment requests of two or more of the passengers;
charging or compensating the passengers in accordance with the reassigned seats and trade values; and
informing the passengers of the reassigned seats.

2. The method of claim 1 wherein the at least one seat attribute includes at least one of type, class, relative location in a row, and row or rows on the plane.

3. The method of claim 1 wherein at least one trade value reflects compensation to be received for giving up a preassigned seat.

4. The method of claim 1 where the trade value includes at least one of cash, a cash equivalent, airline miles, rewards points, or food or drink vouchers.

5. The method of claim 1 wherein the step of using a processor to compute is performed at a predetermined time relative to the flight's scheduled departure time.

6. The method of claim 1 wherein the step of using a processor to compute is performed a plurality of times prior to the flight's departure.

7. The method of claim 1 wherein the processor computes a configuration of reassigned seats using an optimization criterion.

8. A method for facilitating seat reassignment for airline passengers who have preassigned seats on a flight, the method comprising:
receiving via a user interface seat reassignment requests for the flight from a plurality of passengers, the request including at least one of a seat attribute and a trade value;
storing the requests in a memory; and
accessing the stored requests with a processor and using the processor to compute a reassigned seating configuration, wherein the computation jointly uses the reassignment requests of two or more of the passengers.

9. The method of claim 8 wherein a trade value for at least one passenger reflects compensation received by the passenger for giving up a preassigned seat.

10. The method of claim 8, further comprising the step of preauthorizing a charge for a trade value paid by a passenger for receiving a desired seat reassignment.

11. The method of claim 8 wherein the step of receiving includes receiving more than one reassignment request from a passenger.

12. A method for reassigning seats for airline passengers who have been preassigned seats on a flight, the method comprising:
accessing information about seat reassignment requests that have been made by a plurality of passengers, the reassignment requests including at least one of a seat attribute and a trade value; and
using a processor to compute a reassigned seating configuration, wherein the computation jointly uses the reassignment requests of two or more of the passengers.

13. The method of claim 12 wherein the processor optimizes the reassigned seating configuration according to at least one predetermined criterion.

14. The method of claim 13 wherein the at least one predetermined criterion includes at least one of number of successful seat reassignments, total trade value received by or from the passengers, the airline's total revenue, cost, or profit resulting from the reassignment, and difference between the airline's total cost for the reassignment and net total trade value received by the passengers.

15. The method of claim 12 wherein one or more of the reassignment requests is received via a display interface made available to the passengers.

16. The method of claim 12 wherein the trade values can be selected by the passengers.

17. The method of claim 12 wherein the accessing and using steps are performed by an entity other than an airline and further including the step of:
informing the airline of the reassigned seating configuration.

18. A method for reassigning a seat for an airline passenger who has been preassigned to a seat on a flight, the method comprising:
receiving from the passenger a seat reassignment request for the flight, the request comprising at least one of a seat attribute and a trade value;
storing the request; and
using a processor, one or more times after the passenger has been preassigned, to access and attempt to fulfil the request.

19. The method of claim 18, wherein the processor stops accessing and attempting to fulfil the request at a predetermined time relative to the flight's scheduled departure time.

20. The method of claim 18, wherein the receiving and storing steps are performed for a plurality of passengers and the step of using a processor is performed by jointly using the reassignment requests of two or more of the passengers.

21. The method of claim 20, wherein the processor uses an optimization criterion to reassign passengers.

22. The method of claim 21, wherein the trade value is negative for at least one reassigned passenger.

23. A method for reassigning seats for airline passengers who have preassigned seats on a flight, comprising:
accessing information about seat reassignment requests that have been made by a plurality of passengers, the reassignment requests including at least a seat attribute or a trade value; and
using a processor to compute reassigned seats for the passengers wherein the reassigned seats may be such that, if intermediate sequential moves of individual passengers were used to move from the preassigned seats to the reassigned seats, then at least one passenger would be assigned to an invalid seat during at least one of the intermediate moves.
